(19) United States
(12) Patent Application Publication
(10) Pub. No.: US 2012/0125095 A1
(43) Pub. Date: May 24, 2012

(54) Washing machine and method to detect suds thereof

(75) Inventors: Jun Hyun Park, Osani-si (KR); Kyo Soon Choi, Seoul (KR)

(73) Assignee: SAMSUNG ELECTRONICS CO., LTD., Suwon-si (KR)

(21) Appl. No.: 13/373,007

(22) Filed: Nov. 2, 2011

(30) Foreign Application Priority Data
Nov. 24, 2010 (KR) 10-2010-0117484

(51) Int. Cl. G01F 23/00; D06F 37/20; D06F 21/00; D06F 33/02

(52) U.S. Cl. 73/290 R; 68/12.05

(57) ABSTRACT

A washing machine to detect suds using an acceleration sensor and a method to detect suds thereof are disclosed. By driving a motor and rotating a drum at a predetermined target RPM during a washing cycle and measuring displacement data of the drum changed according to the rotation of the drum, it is possible to accurately detect excess suds in the drum and to increase suds detecting accuracy.

### CROSS-REFERENCE TO RELATED APPLICATIONS

This application claims the priority benefit of Korean Patent Application No. 2010-0117484, filed on Nov. 24, 2010 in the Korean Intellectual Property Office, the disclosure of which is incorporated herein by reference.

### BACKGROUND

1. Field

Embodiments relate to a washing machine to detect suds using an acceleration sensor and a method to detect suds thereof.

2. Description of the Related Art

In general, a washing machine (specifically a drum washing machine) includes a tub to contain water (washing water or rinsing water), a drum rotatably mounted in the tub so as to receive laundry and a motor to generate driving force to rotate the drum. When the cylindrical drum rotates, the laundry received therein rises and falls along an inner wall of the drum so as to perform a washing operation.

Such a washing machine performs a washing operation by executing a washing cycle to remove contaminants from laundry using water (e.g., washing water) in which detergent is dissolved, a rinsing cycle to rinse out suds or residual detergent left in the laundry using water (rinsing water) in which detergent is not dissolved, and a dehydrating cycle to rapidly remove water from the laundry.

In the washing cycle, water (e.g., washing water) and detergent are put into the tub and the drum is horizontally reversed by the driving of the motor so as to generate a water stream to deliver water containing detergent to the laundry, thereby removing contaminants from the laundry. If a user uses excess detergent in the washing cycle, excess suds are generated and flow into a front surface (e.g., a detergent box or the like) of the washing machine or excess suds increase load applied to the washing machine without improving washing performance.

In the related art, a method to detect suds using a variation in current (or a maximum current value) applied to a motor or a method to detect suds using both a water level detected by a water level sensor and a variation in current have been proposed. However, in these methods, errors are generated according to the kind or amount of laundry. Thus, it is difficult to accurately detect excess suds.

### SUMMARY

Therefore, it is an aspect to provide a washing machine to accurately detect excess suds using an acceleration sensor to measure vibration of the washing machine and a method to detect suds thereof.

Additional aspects will be set forth in part in the description which follows and, in part, will be apparent from the description, or may be learned by practice of the invention.

In accordance with one aspect, there is provided a method to detect suds in a washing machine including a tub, a drum provided in the tub to receive laundry, and a motor to rotate the drum, the method including driving the motor and rotating the drum at a predetermined target revolutions per minute (RPM) during a washing cycle, measuring displacement data of the drum changed according to the rotation of the drum, and comparing the measured displacement data with a predetermined value and detecting whether or not excess suds are generated in the drum.

The measuring of the displacement data may include measuring the displacement data of the drum vertically changed during a motor on time when the drum rotates at the predetermined target RPM.

The method may further comprise calculating an average value of the displacement data measured during the motor on time.

The detecting of whether or not the excess suds are generated in the drum may include comparing the calculated average value of the displacement data with the predetermined value, and determining that excess suds are generated in the drum if the average value of the displacement data is equal to or less than the predetermined value.

The method may further includes counting the number of suds detecting errors upon detecting that excess suds are generated in the drum, and comparing the counted number of suds detecting errors with a predetermined reference number and executing a suds removal cycle if the number of suds detecting errors exceeds the predetermined reference number.

The suds removal cycle may be executed by stopping the motor for a predetermined time and removing suds through a drain operation if suds dissipate.

In accordance with another aspect, there is provided a washing machine including: a tub to receive water, a drum provided in the tub to receive laundry, a motor to rotate the drum, a displacement sensor provided outside the tub to measure displacement data of the drum, and a controller to drive the motor at a predetermined target RPM, to rotate drum, to measure the displacement data changed according to the rotation of the drum using the displacement sensor, and to detect whether or not excess suds are generated in the drum.

The displacement sensor may include an acceleration sensor, microelectricmechanical system (MEMS) sensor, and an angular speed sensor. One or more displacement sensors may be provided in the tub.

The displacement sensor may be provided on at least one of an upper side of a front surface of the tub, a lower side of the front surface of the tub, an upper side of a rear surface of the tub, and a lower side of the rear surface of the tub.

The controller may extract the vertical displacement data of the drum for a motor on time when the drum rotates at the predetermined target RPM from the displacement sensor.

The controller may calculate an average value of the displacement data extracted during the motor on time, compare the calculated average value of the displacement data with a predetermined value, and determine that excess suds are generated in the drum if the average value of the displacement data is equal to or less than the predetermined value.

The controller may count the number of suds detecting errors upon detecting that excess suds have been generated in the drum, compare the counted number of suds detecting errors with a predetermined reference number, and execute a suds removal cycle if the number of suds detecting errors exceeds the predetermined reference number.

The controller may count the number of suds detecting errors upon detecting that excess suds are generated in the drum, compare the counted number of suds detecting errors with a predetermined reference number, and detects whether or not excess suds have been generated again if the number of suds detecting errors is equal to or less than the predetermined reference number.

The controller may calculate an average value of the displacement data extracted during the motor on time, compare the calculated average value of the displacement data with a predetermined value, and execute a washing cycle if the average value of the displacement data is greater than the predetermined value.

### BRIEF DESCRIPTION OF THE DRAWINGS

These and/or other aspects will become apparent and more readily appreciated from the following description of the embodiments, taken in conjunction with the accompanying drawings of which:

FIG. 1 is a cross-sectional view showing the configuration of a washing machine according to an embodiment;

FIG. 2 is a diagram showing an acceleration sensor mounted in the washing machine according to the embodiment;

FIG. 3 is a block diagram showing the control configuration of the washing machine according to the embodiment;

FIG. 4 is a diagram showing a state of laundry received in a drum in a washing cycle of a normal state in the washing machine according to the embodiment;

FIG. 5 is a waveform diagram of a signal output from an acceleration sensor in a state of FIG. 4;

FIG. 6 is a diagram showing a state of laundry received in a drum in a washing cycle in a state in which excess suds are generated in the washing machine according to the embodiment;

FIG. 7 is a waveform diagram of a signal output from an acceleration sensor in a state of FIG. 6;

FIG. 8 is a flowchart illustrating a suds detecting control algorithm of a washing cycle in the washing machine according to the embodiment;

FIG. 9 is a diagram showing an acceleration sensor mounted in a washing machine according to another embodiment;

FIG. 10 is a diagram showing an acceleration sensor mounted in a washing machine according to another embodiment;

FIG. 11 is a diagram showing an acceleration sensor mounted in a washing machine according to another embodiment;

FIG. 12 is a diagram showing an acceleration sensor mounted in a washing machine according to another embodiment; and

FIG. 13 is a diagram showing an acceleration sensor mounted in a washing machine according to another embodiment.

### DETAILED DESCRIPTION

Reference will now be made in detail to the embodiments, examples of which are illustrated in the accompanying drawings, wherein like reference numerals refer to like elements throughout.

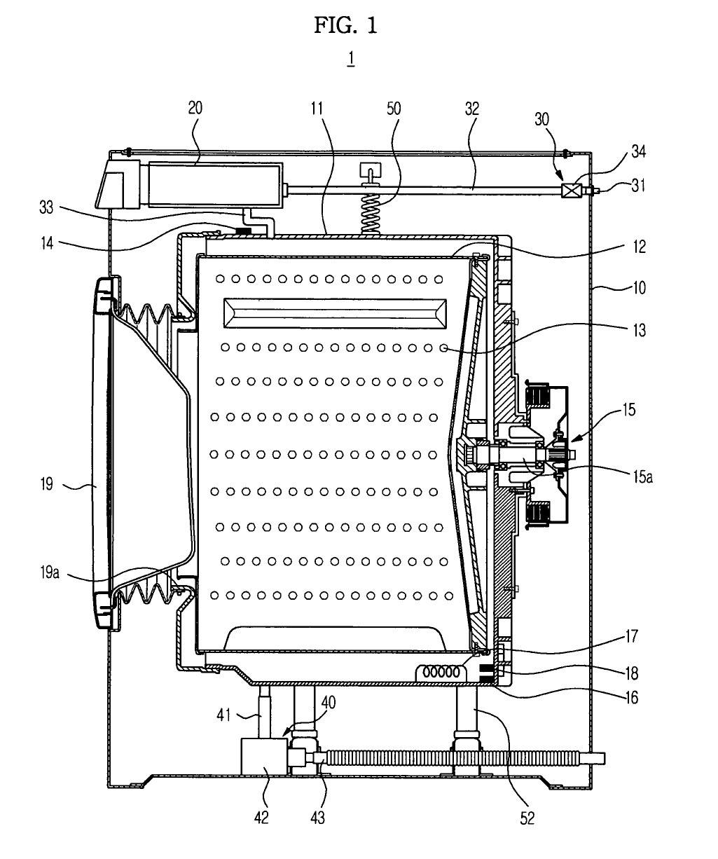

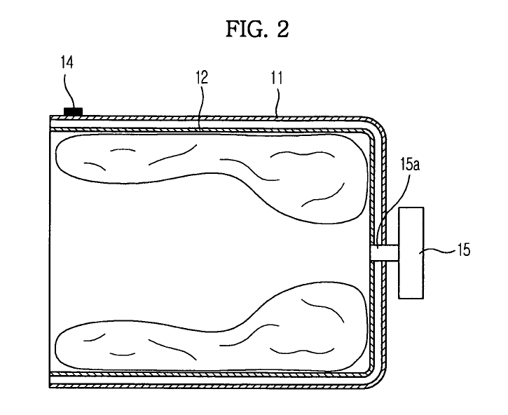

FIG. 1 is a cross-sectional view showing the configuration of a washing machine according to an embodiment, and FIG. 2 is a diagram showing an acceleration sensor mounted in the washing machine according to the embodiment.

In FIGS. 1 and 2, the washing machine 1 according to the embodiment includes a box-shaped main body 10 forming appearance thereof, a drum-type tub 11 mounted in the main body 10 so as to contain water, and a cylindrical drum 12 rotatably mounted in the tub 11 and having a plurality of holes 13 formed therein.

An acceleration sensor 14 to measure vibration of the drum 12 which is generated when the washing machine 1 operates, is provided on an upper side of a front surface of the tub 11. The acceleration sensor 14 includes a three-axis acceleration sensor to measure displacement of the drum 12 in three-directions (X direction, Y direction, and Z direction) by vibration of the drum 12. A displacement signal measured by the acceleration sensor 14 is the primary means used to estimate a balance state of laundry received in the drum 12 during acceleration from a low speed to a high speed so as to determine whether or not a high-speed dehydrating operation may be performed, in order to reduce vibration of the drum 12 in a dehydrating cycle.

In general, in the washing cycle, vertical displacement of the drum 12 occurs due to tumbling of laundry and may be measured by the acceleration sensor 14.

A motor 15 is provided outside a rear surface of the tub as a driving device to rotate a rotation shaft 15a connected to the drum 12 in order to execute a washing cycle, a rinsing cycle, and a dehydrating cycle. A water level sensor 16 to detect frequency changed according to a water level in order to detect the amount of water (water level) contained in the tub 11, a washing heater 17 to heat the water contained in the tub 11, and a temperature sensor 18 to detect the temperature (water temperature) of water contained in the tub 11 are provided on a lower side of the inside of the tub 11.

A door 19 having an opening 19a to enable laundry to be put into or taken out of the drum 12 is provided on a front surface of the main body 10.

A detergent supply device 20 to supply detergent and a water supply device 30 to supply water are provided on an upper side of the tub 11.

A plurality of spaces is partitioned in the detergent supply device 20 and the detergent supply device 20 is provided on the front surface of the main body 10, in order to enable a user to easily put detergent and rinse aid into the spaces.

The water supply device 30 includes a first water supply pipe 32 to connect an external water supply pipe 31 and the detergent supply device 20 in order to supply water into the tub 11, a second water supply pipe 33 to connect the detergent supply device 20 and the tub 11, and a water supply valve 34 provided inline at a point partway along the first water supply pipe 32 to control water supply. By this configuration, water supplied into the tub 11 passes through the detergent supply device 20 such that the detergent in the detergent supply device 20 is supplied into the tub 11 together with water.

The washing machine 1 according to the embodiment includes a drain device 40 to drain water contained in the tub 11. The drain device 40 includes a first drain pipe 41 connected to the lower portion of the tub 11 so as to drain the water from the tub 11, a drain pump 42 provided in the first drain pipe 41 and a second drain pipe 43 connected to an outlet of the drain pump 42.

The washing machine 1 according to the embodiment includes a suspension spring 50 to elastically support the tub 11 on the upper side of the tub 11 in order to prevent vibration generated when the washing machine 1 operates and a damper 52 provided on the lower side of the tub 11 to reduce vibration.

The suspension spring 50 and the damper 52 movably support the tub 11 on the upper and lower sides of the tub 11, respectively. That is, the tub 11 vibrates when the drum 12 rotates, such that vibration is generated in all directions. Vibration of the tub 11 is reduced by the suspension spring 50 and the damper 52.

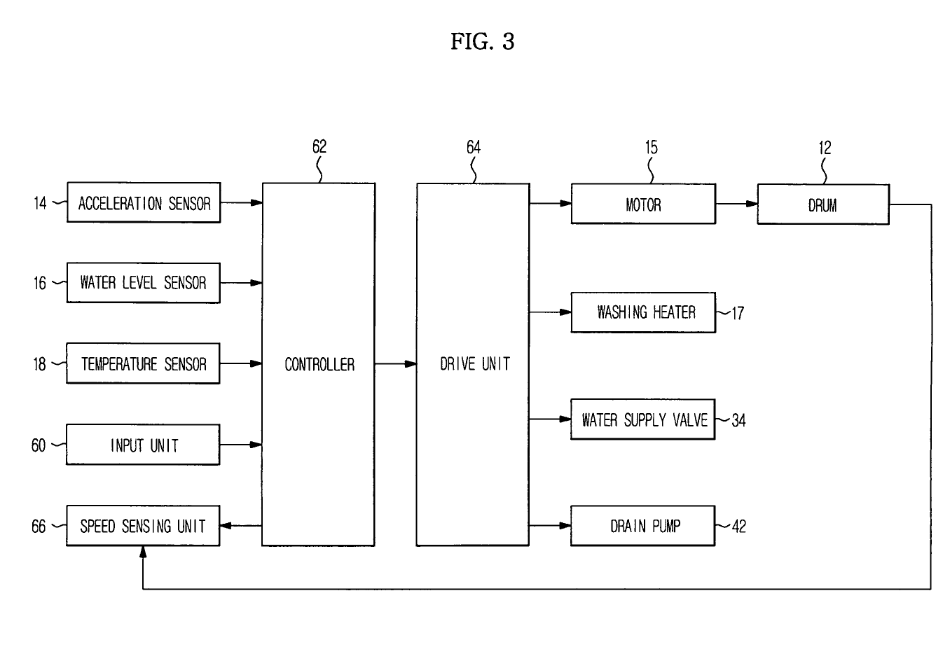

FIG. 3 is a block diagram showing the control configuration of the washing machine according to the embodiment. The washing machine includes an input unit 60, a controller 62, a drive unit 64, and a speed sensing unit 66.

The input unit 60 supplies information input by a user regarding a washing cycle, a rinsing cycle, or a dehydrating cycle of the washing machine 1, and operation information such as a washing course (for example, a standard course, a wool course, etc.), dehydrating RPM, and additional rinsing to the controller 62.

The controller 62 is a micro computer to control the overall operation of the washing machine 1, for example, such as washing, rinsing and dehydrating, according to the operation information received from the input unit 60, and sets washing and rinsing water levels, target RPM, and an operation ratio (motor on/off time), and washing and rinsing times, according to load (amount of laundry) in the selected washing course.

The controller 62 receives vertical displacement data of the drum 12 measured by the acceleration sensor 14 provided in the tub 11 in order to detect an excess suds during the washing cycle.

At this time, the controller 62 may perform signal processing through data filtering in order to extract vertical displacement data of the drum 12 measured by the acceleration sensor 14.

The controller 62 calculates and compares an average value of the received vertical displacement data of the acceleration sensor 14 with a predetermined value (displacement data to determine excess suds during the washing cycle). If the average value of the measured vertical displacement data is equal to or less than the predetermined value, it is determined that excess suds have been generated in the drum 12 and a suds detecting error is generated.

If the suds detecting error is generated, the controller 62 does not immediately execute a suds removal cycle but counts the number of suds detecting errors in order to increase suds detecting accuracy. The counted number of suds detecting errors is compared with a predetermined reference number (to determine whether or not a suds removal cycle is necessary due to generation of excess suds during the washing cycle; for example, about two to five times). If the counted number of suds detecting errors exceeds the predetermined reference number, it is determined that excess suds have been generated in the drum and thus the suds removal cycle is necessary. Then, the suds removal cycle is executed.

In the controller 62, the target RPM (drum RPM during washing cycle; for example, about 30 to 50 RPM) of the drum 12 is set in order to detect generated suds using the acceleration sensor 14.

Accordingly, the controller 62 extracts the vertical displacement data from the acceleration sensor 14 as the drum 12 is operated at the target RPM, that is, during the on time of the motor 15, and detects whether excess suds have been generated in the drum 12.

The drive unit 64 drives the motor 15, the washing heater 17, the water supply valve 34, and the drain pump 42 according to a drive control signal of the controller 62.

The speed sensing unit 66 detects the rate of rotation (RPM) of the drum 12 according to the driving (on time) of the motor 15 and inputs the rate of rotation to the controller 62.

Hereinafter, the operation and effects of the washing machine and the method to detect suds thereof according to the embodiment will be described.

The acceleration sensor 14 used in the washing machine 1 measures vibration of the drum 12 generated when the washing machine 1 operates and determines whether or not a high-speed dehydrating operation is performed in a dehydrating cycle.

In general, in the washing cycle, vertical displacement of the drum 12 is generated by tumbling of laundry in the drum 12 and the vertical displacement of the drum 12 may be measured by the acceleration sensor 14.

Accordingly, in the embodiment, excess suds generated in the washing cycle are sensed using the vertical displacement signal of the drum 12 measured by the acceleration sensor 14.

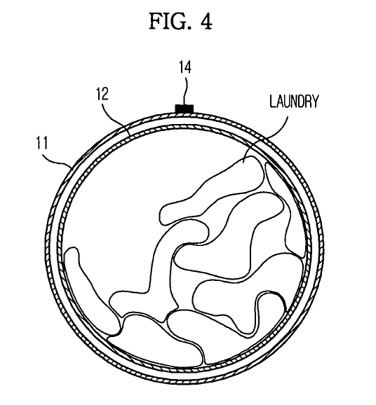

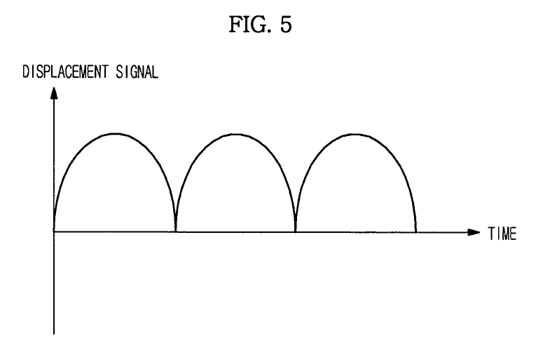

FIG. 4 is a diagram showing a state of laundry received in the drum in a washing cycle of a normal state in the washing machine according to the embodiment, and FIG. 5 is a waveform diagram of a signal output from an acceleration sensor in a state of FIG. 4.

In FIG. 4, in the washing cycle of the normal state in which an appropriate amount of detergent is input, an appropriate amount of suds for the washing cycle is generated. At this time, laundry received in the drum 12 moves according to the rotation of the drum 12 by tumbling along the inner wall of the drum 12.

The displacement of the drum 12 is vertically changed by such tumbling of the laundry and the vertical displacement of the drum 12 is measured by the acceleration sensor 14.

The vertical displacement data of the drum 12 measured by the acceleration sensor 14 is output as an AC voltage signal waveform as shown in FIG. 5 and is sent to the controller 62.

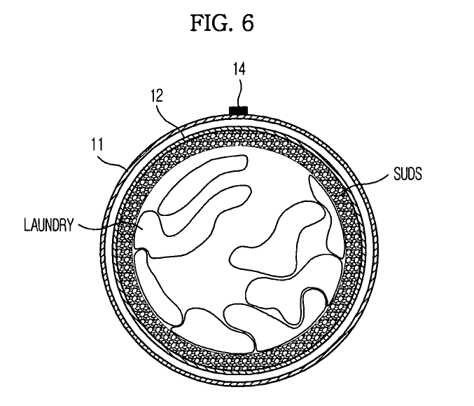

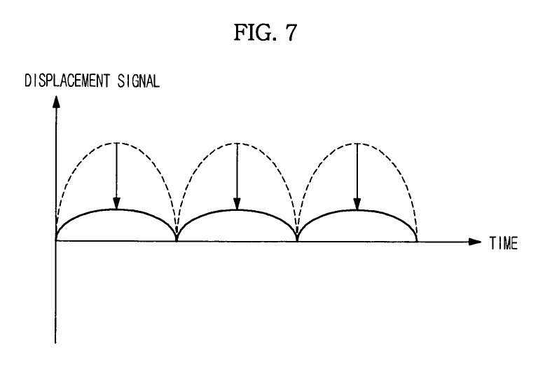

FIG. 6 is a diagram showing a state of laundry received in a drum in a washing cycle in a state in which excess suds are generated in the washing machine according to the embodiment, and FIG. 7 is a waveform diagram of a signal output from an acceleration sensor in a state of FIG. 6.

In FIG. 6, in a washing cycle in which excess detergent has been input, more suds than are necessary for operation of the washing machine are generated and thus are present in the form of a film between the laundry and the inner wall of the drum 12. By such a suds film, tumbling of the laundry along the inner wall of the drum 12 is significantly reduced compared with the tumbling of the laundry in the normal state.

In the washing cycle in which excess suds are generated, the vertical displacement of the drum 12 is reduced compared with in the washing cycle of the normal state and the reduced vertical displacement of the drum 12 is measured by the acceleration sensor 14.

Accordingly, the amplitude of the vertical displacement data of the drum 12 measured by the acceleration sensor 14 is significantly reduced as compared to FIG. 5 as shown in FIG. 7. Thus, it is possible to accurately detect whether or not excess suds are generated in the drum 12 using a variation in displacement data of the acceleration sensor 14.

Although the measurement of the vertical displacement data of the drum 12 according to tumbling of the laundry using the acceleration sensor 14 is described in the embodiment, the embodiments are not limited thereto. Even when a microelectricmechanical system (MEMS) sensor or a gyro sensor is used, the same effects as those of the embodiment may be obtained.

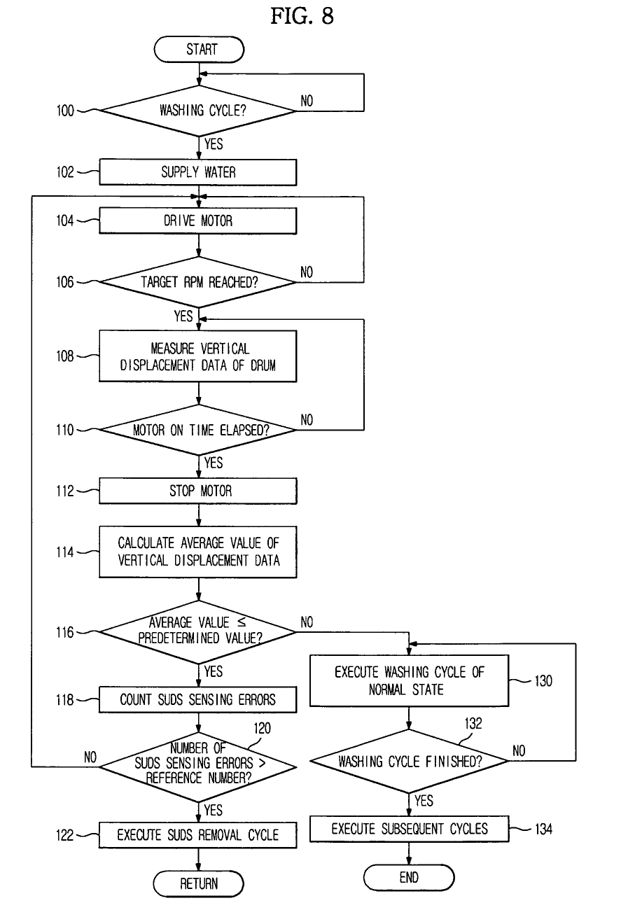

FIG. 8 is a flowchart illustrating a suds detecting control algorithm of a washing cycle in the washing machine according to the embodiment.

In FIG. 8, a user puts laundry into the drum 12 and puts detergent into the detergent supply device 20. When the user inputs operation information associated with a washing course (e.g., a standard course) and the operation of the washing machine 1 according to the kind of the laundry, the operation information selected by the user is input to the controller 62 through the input unit 60.

Then, the controller 62 determines whether a washing cycle is set based on the operation information input through the input unit 60 (100) and begins the washing cycle.

The controller 62 detects load (amount of laundry) of the drum 12 and sets target RPM, operation ratio (motor on/off time), target washing water level, washing time, etc. according to the detected load, in order to execute the washing cycle.

Thereafter, the controller 62 operates the water supply valve 34 in order to supply water necessary for the washing cycle.

If the water supply valve 34 is operated, the water supply valve 34 is opened and water is supplied through the external water supply pipe 31 into the tub 11 (between the tub and the drum) through the first water supply pipe 32, the detergent supply device 20, and the second water supply pipe 33 together with the detergent (102).

Accordingly, the controller 62 detects the level of the water supplied into the tub 11 using the water level sensor 16, determines whether the water level reaches a predetermined target washing water level, and performs the water supply operation until the level of the water supplied into the tub 11 reaches the target washing water level.

If the level of the water supplied into the tub 11 through the water supply operation reaches the target washing water level, the controller 62 closes the water supply valve 34 so as to stop the water supply operation.

Subsequently, the controller 62 drives the motor 15 in order to rotate the drum 12 at the target RPM necessary for the washing cycle (104)

Then, the controller 62 detects the rate of rotation of the drum 12 accelerated by the driving of the motor 15 using the speed sensing unit 66 and determines whether the rate of rotation of the drum 12 reaches the predetermined target RPM (106).

If the rate of rotation of the drum 12 does not reach the target RPM in Operation 106, the motor 15 is driven so as to accelerate the drum 12 until the rate of rotation of the drum reaches the target RPM.

If the rate of rotation of the drum 12 reaches the target RPM in Operation 106, the vertical displacement data of the drum 12 generated by tumbling of the laundry along the inner wall of the drum 12 begins to be measured using the acceleration sensor 14 (108).

The vertical displacement data of the drum 12 measured by the acceleration sensor 14 is output in the form of an AC voltage signal as shown in FIG. 5 or 7 and is sent to the controller 62.

The controller 62 extracts the vertical displacement data of the drum 12 measured by the acceleration sensor 14 while the drum 12 is operated in a state in which the rate of rotation thereof reaches the target RPM, that is, during a motor on time of a predetermined operation ratio (For example, an on time of 5 seconds and an off time of 2 seconds).

Accordingly, the controller 62 begins to measure the vertical displacement data of the drum 12 using the acceleration sensor 14 and determines whether a motor on time has elapsed (110).

If the motor on time has not elapsed in Operation 110, the vertical displacement data of the drum 12 is continuously measured using the acceleration sensor 14 until the motor on time is finished.

If the motor on time has elapsed in Operation 110, the controller 62 stops the motor 15 using the drive unit 64 (112).

Thereafter, the controller 62 calculates the average value of the vertical displacement data of the drum 12 measured by the acceleration sensor 14 while the drum 12 is operated in a state in which the rate of rotation thereof reaches the target RPM, that is, during the on time of the motor 15 (114).

The controller 62 compares the calculated average value of the vertical displacement data with a predetermined value (displacement data to determine whether or not excess suds are generated in the washing cycle) and determines whether the average value of the vertical displacement data is equal to or less than the predetermined value (116).

If the average value of the vertical displacement data is equal to or less than the predetermined value in Operation 116, the controller 62 determines that excess suds are generated in the drum 12 as shown in FIG. 6, generates a suds detecting error, and counts the number of suds detecting errors (118).

When the suds detecting error is generated, a suds removal cycle is not immediately executed and a determination as to whether excess suds are generated is made one more time, thereby increasing suds detecting accuracy.

Accordingly, the controller 62 compares the counted number of suds detecting errors with the predetermined reference number (the number of suds removal cycles executed due to generation of excess suds during the washing cycle; for example, about two to five times) and determines whether the number of suds detecting errors exceeds the reference number (120).

If the number of suds detecting errors does not exceed the reference number in Operation 120, the method proceeds to Operation 104 and the subsequent operations are performed, in order to more accurately detect suds.

If the number of suds detecting errors exceeds the reference number in Operation 120, it is determined that excess suds are generated in the drum 12 and the suds removal cycle is executed (122).

In the suds removal cycle, the motor 15 is stopped, the washing cycle of the washing machine 1 is temporarily stopped, and the washing machine enters a standby state to allow the suds to dissipate. If the standby state continues for a predetermined time (for example, about 30 minutes) such that the suds dissipate, the suds are removed by a drain operation and the washing cycle is executed again.

The suds removal cycle may be executed by supplying water into the tub 11 again, driving the motor 15 (rinsing), and performing a drain operation or a dehydrating operation.

If the average value of the vertical displacement data is greater than the predetermined value in Operation 116, the controller 62 determines that an appropriate amount of suds is generated in the drum 12 as shown in FIG. 4 and the washing cycle is normally executed (130).

In the washing cycle of the normal state, the motor 15 is driven at the target RPM and the operation ratio (motor on/off time), the drum 12 is horizontally reversed by the driving of the motor 15 and a water stream to deliver water containing detergent to the laundry, thereby removing contaminants of the laundry.

Thereafter, the controller 62 determines whether or not the washing cycle is finished based up whether a predetermined washing time has elapsed (132). If the washing cycle is not finished, the method returns to Operation 130 until the washing cycle is finished and the subsequent operations are performed.

If the washing cycle is finished in Operation 132, the controller 62 executes the subsequent cycles thereof (134).

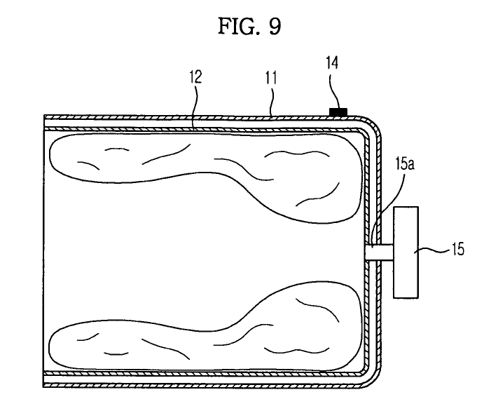

Although one acceleration sensor 14 is mounted on the upper side of the front surface of the tub 11 in the embodiment, the embodiments are not limited thereto. Even when the positions and number of acceleration sensors 14 are changed, the same effects as in the embodiment may be obtained. Examples of another embodiments will be described with reference to FIGS. 9 to 13.

FIG. 9 is a diagram showing an acceleration sensor mounted in a washing machine according to another embodiment.

In FIG. 9, one acceleration sensor 14 is provided on an upper side of a rear surface of the tub 11 and the method of measuring the vertical displacement data of the drum 12 while the drum 12 rotates at the predetermined RPM in the washing cycle and sending the vertical displacement data to the controller 62 is equal to that of FIG. 2.

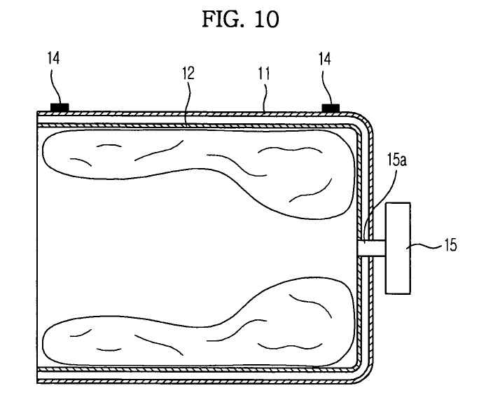

FIG. 10 is a diagram showing an acceleration sensor mounted in a washing machine according to another embodiment.

In FIG. 10, a plurality of acceleration sensors 14 are provided on upper sides of a front surface and a rear surface of the tub 11 and the method of measuring the vertical displacement data of the drum 12 while the drum 12 rotates at the predetermined RPM in the washing cycle and sending the vertical displacement data to the controller 62 is equal to that of FIG. 2.

In this case, the controller 62 calculates an average value of the vertical displacement data measured by the plurality of acceleration sensors 14. Since this method is equal to the method of measuring the vertical displacement data using one acceleration sensor 14 and calculating the average value of the vertical displacement data, it is possible to detect whether or not excess suds are generated in the drum 12 in the same manner as in the embodiment in which one acceleration sensor 14 is provided.

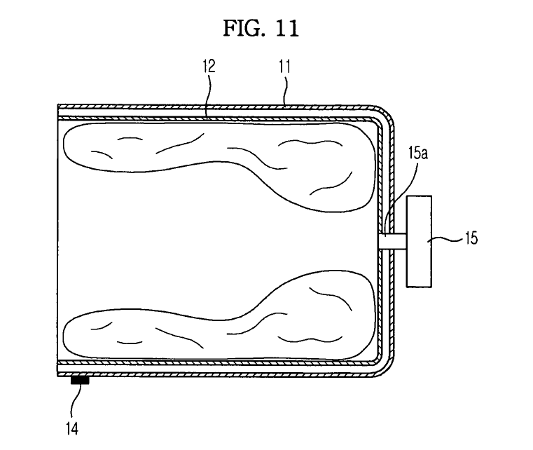

FIG. 11 is a diagram showing an acceleration sensor mounted in a washing machine according to another embodiment

In FIG. 11, one acceleration sensor 14 is provided on a lower side of a front surface of the tub 11 and the method of measuring the vertical displacement data of the drum 12 while the drum 12 rotates at the predetermined RPM in the washing cycle and sending the vertical displacement data to the controller 62 is equal to that of FIG. 2.

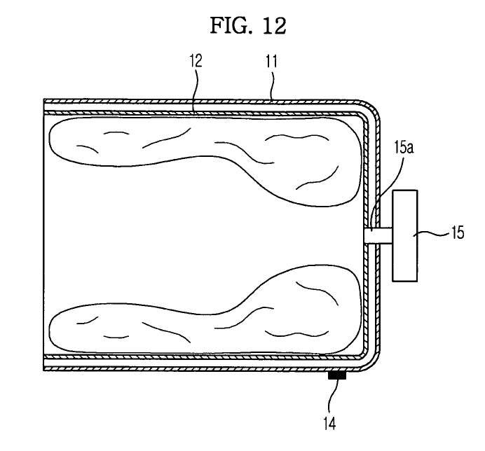

FIG. 12 is a diagram showing an acceleration sensor mounted in a washing machine according to another embodiment.

In FIG. 12, one acceleration sensor 14 is provided on a lower side of a rear surface of the tub 11 and the method of measuring the vertical displacement data of the drum 12 while the drum 12 rotates at the predetermined RPM in the washing cycle and sending the vertical displacement data to the controller 62 is equal to that of FIG. 2.

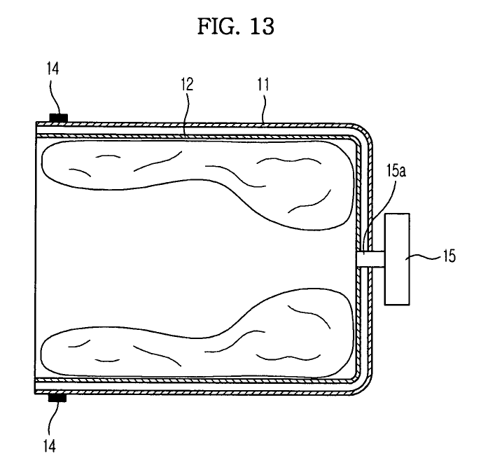

FIG. 13 is a diagram showing an acceleration sensor mounted in a washing machine according to another embodiment.

In FIG. 13, a plurality of acceleration sensors 14 are provided on an upper side and a lower side of a front surface of the tub 11 and the method of measuring the vertical displacement data of the drum 12 while the drum 12 rotates at the predetermined RPM in the washing cycle and sending the vertical displacement data to the controller 62 is equal to that of FIG. 2.

In this case, the controller 62 calculates an average value of the vertical displacement data measured by the plurality of acceleration sensors 14. Since this method is equal to the method of measuring the vertical displacement data using one acceleration sensor 14 and calculating the average value of the vertical displacement data, it is possible to detect whether or not excess suds are generated in the drum 12 in the same manner as in the embodiment in which one acceleration sensor 14 is provided.

In addition to the embodiments shown in FIGS. 9 to 13, the positions and number of acceleration sensors 14 may be modified in a variety of ways.

In the washing machine and the method to detect suds according to the embodiments, it is possible to accurately detect excess suds in a washing cycle using an acceleration sensor to detect vibration of the washing machine and to increase suds detecting accuracy.

Although a few embodiments have been shown and described, it would be appreciated by those skilled in the art that changes may be made in these embodiments without departing from the principles and spirit of the invention, the scope of which is defined in the claims and their equivalents.

1. A method to detect suds in a washing machine including a tub, a drum provided in the tub to receive laundry, and a motor to rotate the drum, the method comprising:
driving the motor and rotating the drum at a predetermined target revolutions per minute (RPM) during a washing cycle;
measuring displacement data of the drum changed according to the rotation of the drum; and
comparing the measured displacement data with a predetermined value and detecting whether or not excess suds are generated in the drum.

2. The method according to claim 1, wherein the measuring of the displacement data includes measuring the displacement data of the drum vertically changed during a motor on time when the drum rotates at the predetermined target RPM.

3. The method according to claim 2, further comprising calculating an average value of the displacement data measured during the motor on time.

4. The method according to claim 3, wherein the detecting of whether or not the excess suds are generated in the drum includes comparing the calculated average value of the displacement data with the predetermined value, and determining that excess suds are generated in the drum if the average value of the displacement data is equal to or less than the predetermined value.

5. The method according to claim 4, further comprising:
counting the number of suds detecting errors upon detecting that excess suds are generated in the drum; and
comparing the counted number of suds detecting errors with a predetermined reference number and executing a suds removal cycle if the number of suds detecting errors exceeds the predetermined reference number.

6. The method according to claim 5, wherein the suds removal cycle is executed by stopping the motor for a predetermined time and removing suds through a drain operation if suds dissipate.

7. A washing machine comprising:
a tub to receive water;
a drum provided in the tub to receive laundry;
a motor to rotate the drum;
a displacement sensor provided outside the tub to measure displacement data of the drum; and
a controller to drive the motor at a predetermined target RPM, to rotate drum, to measure the displacement data changed according to the rotation of the drum using the displacement sensor, and to detect whether or not excess suds are generated in the drum.

8. The washing machine according to claim 7, wherein the displacement sensor includes an acceleration sensor, microelectricmechanical system (MEMS) sensor, and an angular speed sensor.

9. The washing machine according to claim 8, wherein one or more displacement sensors are provided in the tub.

10. The washing machine according to claim 8, wherein the displacement sensor is provided on at least one of an upper side of a front surface of the tub, a lower side of the front surface of the tub, an upper side of a rear surface of the tub, and a lower side of the rear surface of the tub.

11. The washing machine according to claim 7, wherein the controller extracts the vertical displacement data of the drum for a motor on time when the drum rotates at the predetermined target RPM from the displacement sensor.

12. The washing machine according to claim 11, wherein the controller calculates an average value of the displacement data extracted during the motor on time, compares the calculated average value of the displacement data with a predetermined value, and determines that excess suds are generated in the drum if the average value of the displacement data is equal to or less than the predetermined value.

13. The washing machine according to claim 12, wherein the controller counts the number of suds detecting errors upon detecting that excess suds have been generated in the drum, compares the counted number of suds detecting errors with a predetermined reference number, and executes a suds removal cycle if the number of suds detecting errors exceeds the predetermined reference number.

14. The washing machine according to claim 12, wherein the controller counts the number of suds detecting errors upon detecting that excess suds are generated in the drum, compares the counted number of suds detecting errors with a predetermined reference number, and determines whether or not excess suds have been generated again if the number of suds detecting errors is equal to or less than the predetermined reference number.

15. The washing machine according to claim 11, wherein the controller calculates an average value of the displacement data extracted during the motor on time, compares the calculated average value of the displacement data with a predetermined value, and executes a washing cycle if the average value of the displacement data is greater than the predetermined value.

16. The washing machine according to claim 8, wherein the acceleration sensor includes a three-axis acceleration sensor to measure displacement of the drum in three-directions (X direction, Y direction, and Z direction).

17. The washing machine according to claim 7, further comprising a suspension spring to elastically support the tub on an upper side of the tub in order to prevent vibration generated when the washing machine operates, and a damper provided on a lower side of the tub to reduce vibration.
